(19) United States
(12) Patent Application Publication
(10) Pub. No.: US 2022/0027906 A1
(43) Pub. Date: Jan. 27, 2022

(54) PAYMENT PROCESSING METHOD, APPARATUS, DEVICE, AND SYSTEM

(71) Applicant: Alipay (Hangzhou) Information Technology Co., Ltd., Hangzhou (CN)

(72) Inventors: Zhihui TANG, Hangzhou (CN); Jinping WU, Hangzhou (CN); Xinjian LIU, Hangzhou (CN); Hao YUAN, Hangzhou (CN); Xiao LIN, Hangzhou (CN); Qian ZHAO, Hangzhou (CN)

(21) Appl. No.: 17/363,991

(22) Filed: Jun. 30, 2021

(30) Foreign Application Priority Data
Jul. 21, 2020 (CN) 202010704329.1

(51) Int. Cl. G06Q 20/38; G06Q 20/40; G06Q 20/10

(52) U.S. Cl. CPC G06Q 20/38215; G06Q 20/3829; G06Q 20/102; G06Q 20/40145

(57) ABSTRACT

Embodiments of the present specification provide a payment processing method, apparatus, device, and system. The method includes: an Internet of Things (IoT) device determining payment information of a payment to be paid in response to a payment operation of a first user, and collecting to-be-verified biometric feature information of the first user; generating a payment request offline based on the payment information, the biometric feature information, and payment certificate information of the IoT device obtained in advance from a first service terminal; and sending the payment request to a second service terminal, for the second service terminal to send the payment request to the first service terminal, and for the first service terminal to perform payment processing based on the payment information and a payment account of the first user in response to the first service terminal determining that the payment request satisfies a predetermined payment condition. The first service terminal is a service terminal corresponding to a payment application of the first user, and the second service terminal is a service terminal of a merchant corresponding to the IoT device.

### BACKGROUND

### Technical Field

The present specification relates to the field of data processing technologies, and in particular, to a payment processing method, apparatus, device, and system.

### Description of the Related Art

With the continuous development of science and technology, facial recognition payment has been widely used in daily life. Currently, facial recognition payment is usually performed when an intelligent device with a facial recognition payment function is connected to the Internet. However, when facial recognition payment is performed at places such as underground restaurants, closed shopping malls, etc., due to problems such as network instability or inaccessibility, the facial recognition payment fails.

### BRIEF SUMMARY

One or more embodiments of the present specification provide a payment processing method, apparatus, device, and system, which solve the problem that facial recognition payment fails due to network instability or inaccessibility.

One or more embodiments of the present specification provide the following solutions:

One or more embodiments of the present specification provide a payment processing method, which is applied to an Internet of Things (IoT) device. The method includes: determining payment information of a payment to be paid in response to a payment operation of a first user, and collecting to-be-verified biometric feature information of the first user; generating a payment request offline based on the payment information, the biometric feature information, and payment certificate information of the IoT device obtained in advance from a first service terminal, where the first service terminal is a service terminal corresponding to a payment application of the first user, and the payment certificate information includes certificate data and a private key; and sending the payment request to a second service terminal, for the second service terminal to send the payment request to the first service terminal, and for the first service terminal to perform payment processing based on the payment information and a payment account of the payment application in response to the first service terminal determining that the payment request satisfies a predetermined payment condition, where the second service terminal is a service terminal of a merchant corresponding to the IoT device.

One or more embodiments of the present specification provide a payment processing method, which is applied to a first service terminal corresponding to a payment application. The method includes: receiving a payment request sent by a second service terminal, where the payment request is sent by an IoT device to the second service terminal; the payment request is generated offline by the IoT device in response to a payment operation of a first user based on payment information of a payment to be paid and payment certificate information of the IoT device, where the payment certificate information includes certificate data and a private key; the second service terminal is a service terminal of a merchant corresponding to the IoT device; and determining whether the payment request satisfies a predetermined payment condition; and in response to the payment request satisfying the predetermined payment condition, performing payment processing based on the payment information.

One or more embodiments of the present specification provide a payment processing apparatus, which is applied to an IoT device. The apparatus includes a determination module, configured to determine payment information of a payment to be paid in response to a payment operation of a first user, and collect to-be-verified biometric feature information of the first user. The apparatus further includes a generating module, configured to generate a payment request offline based on the payment information, the biometric feature information, and payment certificate information of the IoT device obtained in advance from a first service terminal, where the first service terminal is a service terminal corresponding to a payment application of the first user, and the payment certificate information includes certificate data and a private key. The apparatus further includes a sending module, configured to send the payment request to a second service terminal, for the second service terminal to send the payment request to the first service terminal, and for the first service terminal to perform payment processing based on the payment information and a payment account of the payment application in response to the first service terminal determining that the payment request satisfies a predetermined payment condition, where the second service terminal is a service terminal of a merchant corresponding to the IoT device.

One or more embodiments of the present specification provide a payment processing apparatus, which is applied to a first service terminal corresponding to a payment application. The apparatus includes a receiving module, configured to receive a payment request sent by a second service terminal, where the payment request is sent by an IoT device to the second service terminal; the payment request is generated offline by the IoT device in response to a payment operation of a first user based on payment information of a payment to be paid and payment certificate information of the IoT, where the payment certificate information includes certificate data and a private key; and the second service terminal is a service terminal of a merchant corresponding to the IoT device. The apparatus further includes a determination module, configured to determine whether the payment request satisfies a predetermined payment condition. The apparatus further includes a processing module, configured to: in response to the determination module determining that the payment request satisfies the payment condition, perform payment processing based on the payment information.

One or more embodiments of the present specification provide a payment processing system. The system includes an IoT device, a first service terminal, and a second service terminal, where the first service terminal is a service terminal corresponding to a payment application, and the second service terminal is a service terminal of a merchant corresponding to the IoT device. The IoT device is configured to determine payment information of a payment to be paid in response to a payment operation of a first user, and collect to-be-verified biometric feature information of the first user; generate a payment request offline based on the payment information, the biometric feature information, and payment certificate information of the IoT device obtained in advance from a first service terminal, where the payment certificate information includes certificate data and a private key; and send the payment request to the second service terminal. The second service terminal is configured to receive the payment request sent by the IoT device, and send the payment request to the first service terminal. The first service terminal is configured to determine whether the received payment request satisfies a predetermined payment condition, and in response to the payment request satisfying the predetermined payment condition, perform payment processing based on the payment information.

One or more embodiments of the present specification provide a payment processing device. The device includes a processor. The device further includes a memory, configured to store a computer-executable instruction. When executed, the computer-executable instruction enables the processor to perform the following operations: determining payment information of a payment to be paid in response to a payment operation of a first user, and collecting to-be-verified biometric feature information of the first user; generating a payment request offline based on the payment information, the biometric feature information, and payment certificate information of the IoT device obtained in advance from a first service terminal, where the first service terminal is a service terminal corresponding to a payment application of the first user, and the payment certificate information includes certificate data and a private key; and sending the payment request to a second service terminal, for the second service terminal to send the payment request to the first service terminal, and for the first service terminal to perform payment processing based on the payment information and a payment account of the payment application in response to the first service terminal determining that the payment request satisfies a predetermined payment condition, where the second service terminal is a service terminal of a merchant corresponding to the IoT device.

One or more embodiments of the present specification provide a payment processing device. The device includes a processor. The device further includes a memory, configured to store a computer-executable instruction. When executed, the computer-executable instruction enables the processor to perform the following operations: receiving a payment request sent by a second service terminal, where the payment request is sent by an IoT device to the second service terminal; the payment request is generated offline by the IoT device in response to a payment operation of a first user based on payment information of a payment to be paid and payment certificate information of the IoT, where the payment certificate information includes certificate data and a private key; the second service terminal is a service terminal of a merchant corresponding to the IoT device; and determining whether the payment request satisfies a predetermined payment condition; and in response to the payment request satisfying the predetermined payment condition, performing payment processing based on the payment information.

One or more embodiments of the present specification provide a storage medium. The storage medium is configured to store a computer-executable instruction. The computer-executable instruction is executed by a processor to perform the following operations: determining payment information of a payment to be paid in response to a payment operation of a first user, and collecting to-be-verified biometric feature information of the first user; generating a payment request offline based on the payment information, the biometric feature information, and payment certificate information of the IoT device obtained in advance from a first service terminal, where the first service terminal is a service terminal corresponding to a payment application of the first user, and the payment certificate information includes certificate data and a private key; and sending the payment request to a second service terminal, for the second service terminal to send the payment request to the first service terminal, and for the first service terminal to perform payment processing based on the payment information and a payment account of the payment application in response to the first service terminal determining that the payment request satisfies a predetermined payment condition, where the second service terminal is a service terminal of a merchant corresponding to the IoT device.

One or more embodiments of the present specification provide a storage medium. The storage medium is configured to store a computer-executable instruction. The computer-executable instruction is executed by a processor to perform the following operations: receiving a payment request sent by a second service terminal, where the payment request is sent by an IoT device to the second service terminal; the payment request is generated offline by the IoT device in response to a payment operation of a first user based on payment information of a payment to be paid and payment certificate information of the IoT device, where the payment certificate information includes certificate data and a private key; the second service terminal is a service terminal of a merchant corresponding to the IoT device; and determining whether the payment request satisfies a predetermined payment condition; and in response to the payment request satisfying the predetermined payment condition, performing payment processing based on the payment information.

### BRIEF DESCRIPTION OF THE SEVERAL VIEWS OF THE DRAWINGS

To describe the technical solutions in one or more embodiments of the present specification or in the existing technology more clearly, the following briefly describes the accompanying drawings needed for describing the embodiments or the existing technology. Clearly, the accompanying drawings in the following descriptions merely show some embodiments of the present specification, and a person of ordinary skill in the art can still derive other drawings from these accompanying drawings without creative efforts.

FIG. 1 is a schematic scenario diagram illustrating a payment processing method according to one or more embodiments of the present specification;

FIG. 2 is a first schematic flowchart illustrating a payment processing method according to one or more embodiments of the present specification;

FIG. 3 is a second schematic flowchart illustrating a payment processing method according to one or more embodiments of the present specification;

FIG. 4 is a third schematic flowchart illustrating a payment processing method according to one or more embodiments of the present specification;

FIG. 5 is a detailed diagram illustrating step S1042 according to one or more embodiments of the present specification;

FIG. 6 is a fourth schematic flowchart illustrating a payment processing method according to one or more embodiments of the present specification;

FIG. 7 is a fifth schematic flowchart illustrating a payment processing method according to one or more embodiments of the present specification;

FIG. 8 is a sixth schematic flowchart illustrating a payment processing method according to one or more embodiments of the present specification;

FIG. 9 is a seventh schematic flowchart illustrating a payment processing method according to one or more embodiments of the present specification;

FIG. 10 is an eighth schematic flowchart illustrating a payment processing method according to one or more embodiments of the present specification;

FIG. 11 is a ninth schematic flowchart illustrating a payment processing method according to one or more embodiments of the present specification;

FIG. 12 is a first schematic module composition diagram illustrating a payment processing apparatus according to one or more embodiments of the present specification;

FIG. 13 is a second schematic module composition diagram illustrating a payment processing apparatus according to one or more embodiments of the present specification;

FIG. 14 is a schematic composition diagram illustrating a payment processing system according to one or more embodiments of the present specification; and

FIG. 15 is a schematic structural diagram illustrating a payment processing device according to one or more embodiments of the present specification.

### DETAILED DESCRIPTION

To enable a person skilled in the art to better understand the technical solutions in one or more embodiments of the present specification, the following clearly and fully describes the technical solutions in one or more embodiments of the present specification with reference to the accompanying drawings in one or more embodiments of the present specification. Clearly, the described embodiments are merely some rather than all of the embodiments of the present specification. Based on one or more embodiments of the present specification, all other embodiments obtained by a person of ordinary skill in the art without creative efforts shall fall within the protection scope of the present specification.

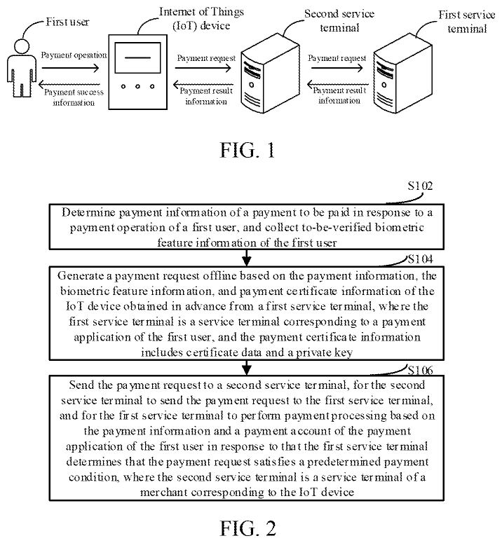

FIG. 1 is a schematic diagram illustrating an application scenario of a payment processing method according to one or more embodiments of the present specification. As shown in FIG. 1, the scenario includes an Internet of Things (IoT) device, a first service terminal, and a second service terminal. The IoT device is a standard or nonstandard computing device that is capable of transmitting data with or via a network through wireless connection or wired connection. The IoT device is also referred to as a connected device. Connected devices are part of an IoT ecosystem in which every device talks to other related devices in an environment to automate home, business or industry tasks. They can communicate usable sensor data to users, businesses and other intended parties. The IoT device is a physical object designed to interact with the real world environment in a physical way, e.g., through sensor data. That is, the IoT device senses what is happening in the physical world. The IoT device itself may include an integrated CPU, network adapter and firmware. In some implementations, the IoT device connect to a Dynamic Host Configuration Protocol server and acquire an IP address that the IoT device can use to function on the network. The IoT device may be directly accessible over the public internet, or may operate exclusively on private networks. In some implementations, the IoT device is configured and managed through a software application.

A first user pays a merchant corresponding to the IoT device based on a biometric feature recognition payment service and by using the IoT device. The first service terminal is a service terminal corresponding to a payment application of the first user, and the second service terminal is a service terminal of the merchant corresponding to the IoT device. The first service terminal and the second service terminal each can be a standalone service terminal, or a service terminal cluster that includes a plurality of service terminals.

For example, the IoT device determines payment information of a payment to be paid in response to a payment operation of the first user, and collects to-be-verified biometric feature information of the first user; the IoT device generates a payment request offline based on the determined payment information, the collected biometric feature information, and payment certificate information of the IoT device obtained in advance from the first service terminal, and displays payment success information; the IoT device sends the generated payment request to the second service terminal; the second service terminal sends the received payment request to the first service terminal; in response to determining that the received payment request satisfies a predetermined payment condition, the first service terminal performs payment processing based on the payment information included in the payment request and a payment account of the payment application of the first user, and sends processing result information to the second service terminal; and the second service terminal sends the received processing result information to the IoT device.

The payment certificate information includes certificate data and a private key. Offline generation of the payment request means that the IoT device generates the payment request when being disconnected from the network. In other words, the IoT device generates the payment request without depending on the network, thereby effectively avoiding the problem of payment failure due to network instability or inaccessibility, and greatly improving payment efficiency. In addition, because the merchant cannot participate in the offline generation of the payment request, forging data by the merchant is effectively avoided. What's more, the first service terminal performs payment processing when determining that the payment request satisfies the predetermined payment condition, thereby effectively ensuring payment security.

Further, considering that the IoT device needs to perform data communication with the service terminal based on the network, to avoid a low data transmission speed caused by network instability or inaccessibility, which causes the user to wait for a long time, in the embodiments of the present specification, payment is implemented through asynchronous processing. That is, when generating the payment request offline, the IoT device displays the payment success information. The perception of the user is that payment has been successful. However, after displaying the payment success information, the IoT device sends the payment request to the first service terminal through the second service terminal based on the network, so as to complete the actual payment. This process not only can ensure effective payment, but also can prevent the first user from waiting for a long time, thereby improving user experience.

FIG. 2 is a schematic flowchart illustrating a payment processing method according to one or more embodiments of the present specification. The method in FIG. 2 can be performed by the IoT device in FIG. 1. As shown in FIG. 2, the method includes the following steps:

Step S102: Determine payment information of a payment to be paid in response to a payment operation of a first user, and collect to-be-verified biometric feature information of the first user.

In some examples, the first user operates the IoT device to select a product that needs to be purchased, and after completion of the product selection, operates a payment control of the IoT device to pay the merchant corresponding to the IoT device for the selected product. The IoT device determines payment information based on product information (such as a quantity, a price, etc.) of the product selected by the first user in response to the payment operation of the first user, and collects to-be-verified biometric feature information of the first user. The biometric feature information includes a face image, a fingerprint image, an iris image, etc., which is not, for example, limited in this application.

It should be noted that the interaction between the first user and the IoT device is not limited to the previous examples, and can be configured depending on the need in actual practice. For example, the merchant can also operate the IoT device based on the product to be purchased by the first user, to enter product information, and the IoT device displays the product information entered by the merchant. After determining that the product information displayed by the IoT device is correct, the first user operates the payment control of the IoT device to pay the merchant corresponding to the IoT device for the selected product.

Step S104: Generate a payment request offline based on the payment information, the biometric feature information, and payment certificate information of the IoT device obtained in advance from a first service terminal, where the first service terminal is a service terminal corresponding to a payment application of the first user, and the payment certificate information includes certificate data and a private key.

The certificate data includes device identification information of the IoT device, merchant identification information, validity period information of the certificate data, a public key corresponding to the private key in the payment certificate information, etc. Offline generation of the payment request means that the IoT device generates the payment request when being disconnected from the network. In other words, the IoT device generates the payment request without depending on the network, thereby effectively avoiding the problem of payment failure due to network instability or inaccessibility, and greatly improving payment efficiency.

Step S106: Send the payment request to a second service terminal, for the second service terminal to send the payment request to the first service terminal, and for the first service terminal to perform payment processing based on the payment information and a payment account of the payment application of the first user when the first service terminal determines that the payment request satisfies a predetermined payment condition, where the second service terminal is a service terminal of a merchant corresponding to the IoT device.

When receiving the payment request sent by the IoT device, the second service terminal sends the received payment request to the first service terminal, for the first service terminal to perform payment processing.

In one or more embodiments of the present specification, in response to the payment operation of the first user, the IoT device generates the payment request offline based on the collected biometric feature information of the first user and the payment certificate information obtained in advance from the first service terminal, and sends the payment request to the first service terminal through the second service terminal, for the first service terminal to perform payment processing when determining that the payment request satisfies the predetermined payment condition. Therefore, offline generation of the payment request effectively avoids the problem of payment failure due to network instability or inaccessibility, and greatly improves payment efficiency. In addition, because the merchant cannot participate in the offline generation of the payment request, forging data by the merchant is effectively avoided. What's more, the IoT device generates the payment request based on the payment certificate information obtained from the first service terminal, etc., and the first service terminal performs payment processing when determining that the payment request satisfies the predetermined payment condition, thereby effectively ensuring payment security.

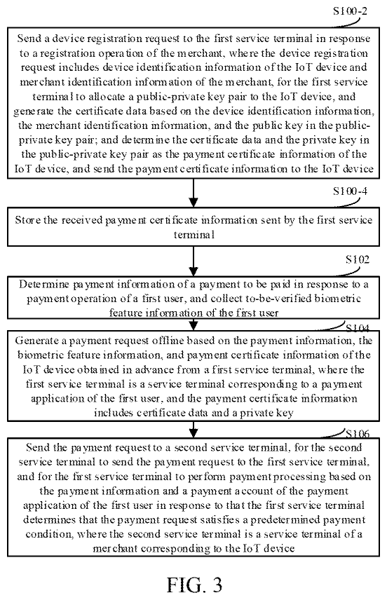

To enable the IoT device to complete the payment smoothly, in one or more embodiments of the present specification, as shown in FIG. 3, before step S102, the method further includes:

Step S100-2: Send a device registration request to the first service terminal in response to a registration operation of the merchant, where the device registration request includes device identification information of the IoT device and merchant identification information of the merchant, for the first service terminal to allocate a public-private key pair to the IoT device, and generate the certificate data based on the device identification information, the merchant identification information, and the public key in the public-private key pair; and determine the certificate data and the private key in the public-private key pair as the payment certificate information of the IoT device, and send the payment certificate information to the IoT device.

Step S100-4: Store the received payment certificate information sent by the first service terminal.

For example, before putting the IoT device into use, the merchant operates the IoT device to submit the merchant identification information. When obtaining the merchant identification information submitted by the merchant, the IoT device generates a device registration request based on the merchant identification information and the device identification information of the IoT device, and sends the device registration request to the first service terminal. When receiving the device registration request, the first service terminal allocates a public-private key pair to the IoT device; generates certificate data based on the device identification information of the IoT device, the merchant identification information, and the public key in the public-private key pair; determines the certificate data and the private key in the public-private key pair as the payment certificate information of the IoT device; sends the payment certificate information to the IoT device; and stores the device identification information, the merchant identification information, the certificate data, etc., as associated with one another. When receiving the payment certificate information sent by the first service terminal, the IoT device stores the payment certificate information so that the IoT device generates a payment request based on the payment certificate information when detecting a payment operation of the first user. In this way, when receiving the payment request, the first service terminal can obtain related information from the payment request and verify the predetermined payment condition to ensure payment security.

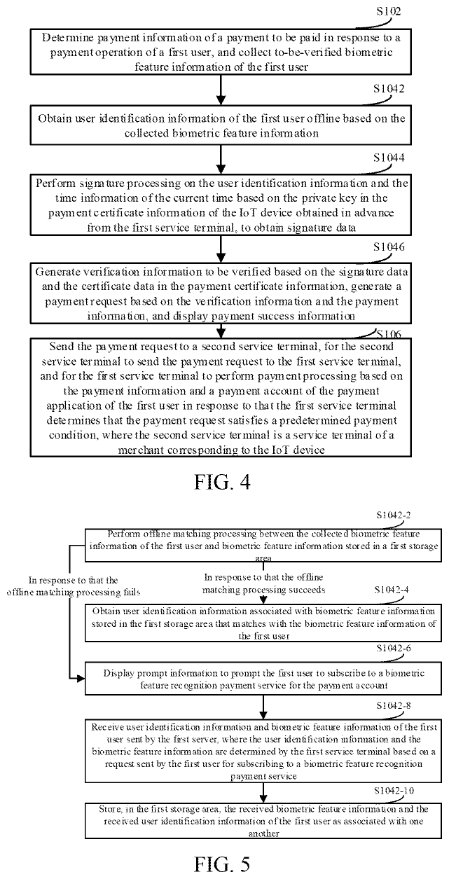

Further, to enable the first service terminal to quickly determine the payment account of the first user when the first service terminal determines that the payment request satisfies the predetermined payment condition and then performs payment processing, in one or more embodiments of the present specification, as shown in FIG. 4, step S104 includes:

Step S1042: Obtain user identification information of the first user offline based on the collected biometric feature information.

For example, as shown in FIG. 5, step S1042 includes:

Step S1042-2: Perform offline matching processing between the collected biometric feature information of the first user and biometric feature information stored in a first storage area. In response to the offline matching processing succeeding, perform step S1042-4. In response to the offline matching processing failing, perform step S1042-6.

The first storage area stores an association relationship between biometric feature information and user identification information of a user who has subscribed to a biometric feature recognition payment service, and the association relationship is obtained in advance from the first service terminal and stored in the first storage area. The user identification information is identification information allocated by the first service terminal to the first user when the user registers the payment account of the payment application. The biometric feature information is information provided by the user when the user registers the payment account of the payment application, or is information collected by the first service terminal when the first service terminal subscribes to a biometric feature recognition payment service based on a subscription request of the user. Offline matching processing means that the matching processing is performed without depending on the network, and the matching processing can be completed when the IoT device is not connected to the network or the network is unstable.

Step S1042-4: Obtain the user identification information of the first user from the association relationship between the biometric feature information and the user identification information stored in the first storage area based on the biometric feature information.

Step S1042-6: Display prompt information to prompt the first user to subscribe to a biometric feature recognition payment service for the payment account.

When the offline matching processing fails, it indicates that the first user has not registered a payment account, or indicates that the first user has registered a payment account but has not subscribed to a biometric feature recognition payment service for the payment account, or indicates that the first user has subscribed to a biometric feature recognition payment service for the payment account, but due to factors such as a time difference or a network, the first storage area of the IoT device has not yet stored the biometric feature and the user identification information of the first user.

To avoid displaying prompt information to the first user when the first user has subscribed to the biometric feature recognition payment service for the payment account, in one or more embodiments of the present specification, step S1042-6 includes: sending the collected biometric feature information of the first user to the first service terminal, for the first service terminal to perform matching between the biometric feature information of the first user and the biometric feature information of a user stored on the first service terminal, and send a matching result to the IoT device. In response to determining that the received matching result indicates that the matching succeeds, the IoT device obtains the user identification information of the first user from the matching result, and performs step S1044. In response to determining that the received matching result indicates that the matching fails, the IoT device displays prompt information. Alternatively, step S1042-6 includes: obtaining the association relationship between biometric feature information and user identification information of a user who has subscribed to a biometric feature recognition payment service from the first service terminal, and updating an association relationship stored in the first storage area based on the obtained association relationship; and performing offline matching processing between the collected biometric feature information of the first user and updated biometric feature information in the first storage area, and in response to the offline matching processing succeeding, determining user identification information associated with the successfully matched biometric feature information as the user identification information of the first user, and performing step S1044; and in response to the offline matching processing failing, displaying prompt information. Therefore, when the offline matching processing in step S1042-2 fails, the biometric feature information of the first user is sent online to the first service terminal, for the first service terminal to perform matching processing, or the association relationship between the biometric feature information and the user identification information is obtained from the first service terminal, and the association relationship in the first storage area is updated, so as to perform offline matching processing based on the updated association relationship. This can effectively identify whether the first user has subscribed to the biometric feature recognition payment service for the payment account, and avoid prompting the first user to subscribe to the biometric feature recognition payment service when the first user has subscribed to the biometric feature recognition payment service for the payment account.

Step S1042-8: Receive user identification information and biometric feature information of the first user sent by the first service terminal, where the user identification information and the biometric feature information are determined by the first service terminal based on a request sent by the first user for subscribing to a biometric feature recognition payment service.

For example, when the first user has not registered a payment account, the first user operates his/her terminal device to send an account registration request to the first service terminal based on the prompt information displayed by the IoT device. The first service terminal performs account registration processing based on the account registration request to obtain the user identification information of the first user and the account information of the payment account, and sends account registration success information to the first user. When receiving the account registration success information, the first user operates his/her terminal device to send a subscription request to the first service terminal to request to subscribe to the biometric feature recognition payment service for the payment account. The first service terminal obtains the biometric feature information of the first user based on the received subscription request, and performs the subscription processing of the biometric feature recognition payment service for the payment account based on the obtained biometric feature information. After the subscription processing succeeds, the first service terminal sends subscription success information to the first user, and sends the biometric feature information and the user identification information of the first user to the IoT device. When receiving the subscription success information, the first user can perform payment again based on the IoT device. Obtaining the biometric feature information of the first user can be obtaining the biometric feature information in the account registration request stored during the account registration processing, or sending a biometric feature collection request to the terminal device of the first user and receiving the biometric feature information sent by the terminal device.

When the first user has registered a payment account but has not subscribed to a biometric feature recognition payment service for the payment account, the first user operates his/her terminal device to send a subscription request to the first service terminal, to request to subscribe to the biometric feature recognition payment service for the payment account. The first service terminal performs the subscription processing by using the previous method.

Step S1042-10: Store, in the first storage area, the received biometric feature information and the received user identification information of the first user as associated with one another.

The biometric feature information and the user identification information of a user are obtained in advance from the first service terminal. In this way, the payment request can be generated offline based on the obtained information. When the offline matching processing fails, the prompt information is displayed, and the biometric feature information and the user identification information of the first user sent by the first service terminal are stored in the first storage area as associated with one another. In this way, corresponding processing can be performed when the first user performs a payment operation again.

Further, to avoid the problem that the IoT device does not receive the user identification information and the biometric feature information sent by the first service terminal due to a network factor, in one or more embodiments of the present specification, the method further includes: obtaining, from the first service terminal and at a predetermined time interval, biometric feature information and user identification information of a user who has subscribed to a biometric feature recognition payment service; and storing, in the first storage area, the obtained biometric feature information and the obtained user identification information of the first user as associated with one another.

According to some implementations, biometric feature information and user identification information of a user who has subscribed to a biometric feature recognition payment service within a corresponding time interval are obtained from the first service terminal and at a predetermined time interval; and the obtained biometric feature information and the obtained user identification information are stored in the first storage area as associated with one another. For example, the predetermined time interval is 60 minutes, and at 12:00 on a certain day, biometric feature information and user identification information of a user who has subscribed to a biometric feature recognition payment service between 11:00 and 12:00 on that day are obtained from the first service terminal; the obtained biometric feature information and the obtained user identification information of the user are stored in the first storage area as associated with one another; at 13:00 on that day, biometric feature information and user identification information of a user who has subscribed to a biometric feature recognition payment service between 12:00 and 13:00 on that day are obtained from the first service terminal; the obtained biometric feature information and the obtained user identification information of the user are stored in the first storage area as associated with one another. Alternatively, biometric feature information and user identification information of all users who have subscribed to a biometric feature recognition payment service are obtained from the first service terminal and at a predetermined time interval; and the obtained biometric feature information and the obtained user identification information of the user are stored in the first storage area as associated with one another. For example, the predetermined time interval is 60 minutes, and at 12:00 on a certain day, biometric feature information and user identification information of all users who have subscribed to a biometric feature recognition payment service are obtained from the first service terminal; the association relationship between the biometric feature information and the user identification information of a user currently stored in the first storage area is deleted; and the obtained biometric feature information and the obtained user identification information of the user are stored in the first storage area as associated with one another. At 13:00 on that day, biometric feature information and user identification information of all users who have subscribed to a biometric feature recognition payment service are obtained from the first service terminal; the association relationship between the biometric feature information and the user identification information of a user currently stored in the first storage area is deleted; and the currently obtained biometric feature information and the currently obtained user identification information of the user are stored in the first storage area as associated with one another.

Further, the first service terminal can open a data acquisition interface for the IoT device, and the IoT device obtains the biometric feature information and the user identification information of a user who has subscribed to a biometric feature recognition payment service from the first service terminal through the data acquisition interface at a predetermined time interval. Alternatively, the IoT device sends a data acquisition request to the first service terminal at a predetermined time interval, and receives the biometric feature information and the user identification information of a user who has subscribed to a biometric feature recognition payment service from the first service terminal.

It should be noted that when receiving the payment certificate information sent by the first service terminal, the IoT device obtains the association relationship between the biometric feature information and the user identification information for the first time. The method in which the IoT device obtains the biometric feature information and the user identification information of a user who has subscribed to a biometric feature recognition payment service from the first service terminal can be configured depending on the need in actual practice.

Further, when the number of users who have registered a payment account and subscribed to a biometric feature recognition payment service is excessively large, the IoT device needs to have a first storage area with a large storage capacity, and an offline matching rate may be affected by excessive biometric feature information stored in the first storage area. Based on the previous consideration, in one or more embodiments of the present specification, the obtaining the association relationship between the biometric feature information and the user identification information of a user who has subscribed to a biometric feature recognition payment service from the first service terminal can include: obtaining the association relationship between biometric feature information and user identification information of a user who has subscribed to a biometric feature recognition payment service and satisfies a predetermined condition from the first service terminal. For example, the predetermined condition is that a home address is located in a region in which the IoT device is located (such as a certain city, a certain street, or a certain community, etc.). For another example, the predetermined condition is that a user is an employee of a certain company. The predetermined condition can be configured depending on the need in actual practice. This not only can prevent the IoT device from storing a large amount of user information, thereby increasing the offline matching rate, but also can ensure security of the user information.

Step S1044: Perform signature processing on the user identification information and the time information of the current time based on the private key in the payment certificate information of the IoT device obtained in advance from the first service terminal, to obtain signature data.

For example, the current time is obtained, and signature processing is performed on the determined user identification information and time information of the obtained current time based on the private key in the payment certificate information, to obtain the signature data. The signature data is generated based on the time information of the current time to ensure uniqueness of the signature data. In this way, the signature data generated by the first user for a payment is different. Even if the current signature data is stolen, the stealer cannot impersonate the first user to perform a subsequent payment, thereby ensuring payment security.

Step S1046: Generate verification information to be verified based on the signature data and the certificate data in the payment certificate information, generate a payment request based on the verification information and the payment information, and display payment success information.

For example, the signature data and the certificate data in the payment certificate information are spliced, the spliced data is determined as the verification information to be verified, the payment request is generated based on the verification information and the payment information, and the payment success information is displayed.

It should be noted that, considering that the IoT device needs to perform data communication with the service terminal based on the network, to avoid a low data transmission speed caused by network instability or inaccessibility, which causes the user to wait for a long time, in the embodiments of the present specification, payment is implemented through asynchronous processing. That is, when generating the payment request offline, the IoT device displays the payment success information. The perception of the user succeeds payment. However, after displaying the payment success information, the IoT device sends the payment request to the first service terminal through the second service terminal based on the network, so as to complete the actual payment. This process not only can ensure effective payment, but also can prevent the first user from waiting for a long time, thereby improving user experience.

Therefore, the IoT device performs offline matching of biometric feature information based on the stored user identification information and the associated biometric feature information to determine the user identification information of the first user, and generates signature data based on the user identification information and the current time, so as to generate the payment request based on the signature data and the certificate data. In this way, offline generation of the payment request is implemented, and payment failure caused by the network is effectively avoided. In addition, the signature data is generated based on the current time, ensuring the uniqueness of the signature data, and further ensuring payment security. Furthermore, the offline generation process of the payment request is carried out in the IoT device, and the merchant cannot participate in this process, thereby preventing the merchant from forging data and further ensuring payment security.

To avoid a security risk caused by leakage of certificate data of the IoT device, in one or more embodiments of the present specification, when generating the certificate data, the first service terminal further sets a validity period of the certificate data. When the validity period of the certificate data expires, the IoT device can request the first service terminal to update the certificate data. For example, the method further includes: in response to determining that the validity period of the certificate data expires, sending a certificate update request to the first service terminal based on the certificate data, for the first service terminal to perform certificate update processing, and send updated new certificate data to the IoT device; and receiving the new certificate data sent by the IoT device, and storing the received new certificate data.

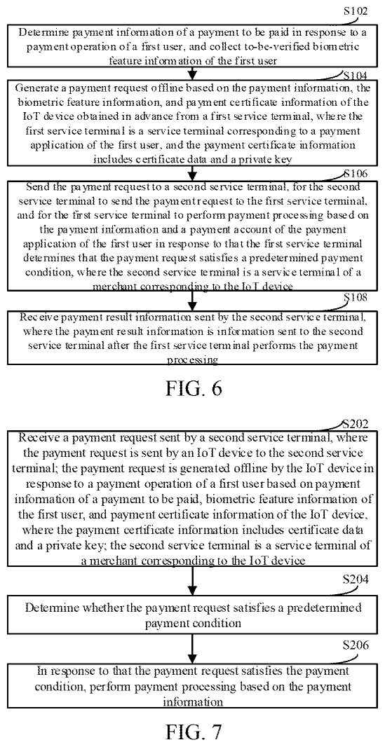

Further, to make the IoT device aware of the payment processing result of the first service terminal, in one or more embodiments of the present specification, as shown in FIG. 6, after step S106, the method further includes:

Step S108: Receive payment result information sent by the second service terminal, where the payment result information is information sent to the second service terminal after the first service terminal has performed the payment processing.

For example, the first service terminal sends the payment result information to the second service terminal, and the second service terminal sends the received payment result information to the IoT device.

In one or more embodiments of the present specification, in response to the payment operation of the first user, the IoT device generates the payment request offline based on the collected biometric feature information of the first user and the payment certificate information obtained in advance from the first service terminal, and sends the payment request to the first service terminal through the second service terminal, for the first service terminal to perform payment processing when determining that the payment request satisfies the predetermined payment condition. Therefore, offline generation of the payment request effectively avoids the problem of payment failure due to network instability or inaccessibility, and greatly improves payment efficiency. In addition, because the merchant cannot participate in the offline generation of the payment request, forging data by the merchant is effectively avoided. What's more, the IoT device generates the payment request based on the payment certificate information obtained from the first service terminal, etc., and the first service terminal performs payment processing when determining that the payment request satisfies the predetermined payment condition, thereby effectively ensuring payment security.

Corresponding to the payment processing method described in FIG. 2 to FIG. 6, based on the same technical concept, one or more embodiments of the present specification further provide another payment processing method. FIG. 7 is a schematic flowchart illustrating another payment processing method according to one or more embodiments of the present specification. The method in FIG. 7 can be performed by the first service terminal in FIG. 1. As shown in FIG. 7, the method includes the following steps:

Step S202: Receive a payment request sent by a second service terminal, where the payment request is sent by an IoT device to the second service terminal; the payment request is generated offline by the IoT device in response to a payment operation of a first user based on payment information of a payment to be paid, biometric feature information of the first user, and payment certificate information of the IoT device, where the payment certificate information includes certificate data and a private key; the second service terminal is a service terminal of a merchant corresponding to the IoT device.

Step S204: Determine whether the payment request satisfies a predetermined payment condition.

Step S206: In response to the payment request satisfying the payment condition, perform payment processing based on the payment information.

Further, in response to the payment request not satisfying the payment condition, payment failure information is sent to the second service terminal, for the second service terminal to send the payment failure information to the IoT device.

In one or more embodiments of the present specification, when the first service terminal receives the payment request sent by the second service terminal, in response to determining that the payment request satisfies the predetermined payment condition, the first service terminal performs payment processing based on the payment information included in the payment request. The payment request is generated offline by the IoT device in response to a payment operation of a first user based on payment information of a payment to be paid, biometric feature information of the first user, and payment certificate information, and is sent to the second service terminal. Therefore, offline generation of the payment request effectively avoids the problem of payment failure due to network instability or inaccessibility, and greatly improves payment efficiency. In addition, because the merchant cannot participate in the offline generation of the payment request, forging data by the merchant is effectively avoided. What's more, the first service terminal performs payment processing when determining that the payment request satisfies the predetermined payment condition, thereby effectively ensuring payment security.

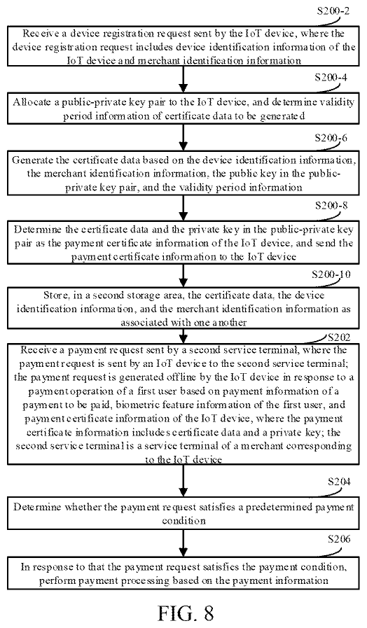

To enable the IoT device to complete the payment smoothly, and enable the first service terminal to verify the payment condition, in one or more embodiments of the present specification, as shown in FIG. 8, before step S202, the method further includes:

Step S200-2: Receive a device registration request sent by the IoT device, where the device registration request includes device identification information of the IoT device and merchant identification information.

For example, before putting the IoT device into use, the merchant operates the IoT device to submit the merchant identification information. When obtaining the merchant identification information submitted by the merchant, the IoT device generates a device registration request based on the merchant identification information and the device identification information of the IoT device, and sends the device registration request to the first service terminal.

Step S200-4: Allocate a public-private key pair to the IoT device, and determine validity period information of certificate data to be generated.

The validity period can be configured depending on the need in actual practice, for example, the validity period is 20 days.

Step S200-6: Generate the certificate data based on the device identification information, the merchant identification information, the public key in the public-private key pair, and the validity period information.

Step S200-8: Determine the certificate data and the private key in the public-private key pair as the payment certificate information of the IoT device, and send the payment certificate information to the IoT device.

Step S200-10: Store, in a second storage area, the certificate data, the device identification information, and the merchant identification information as associated with one another.

The payment certificate information is sent to the IoT device, for the IoT device to generate a payment request based on the payment certificate information when detecting the payment operation of the user. In this way, the first service terminal can verify the payment condition when receiving the payment request, so as to ensure payment security.

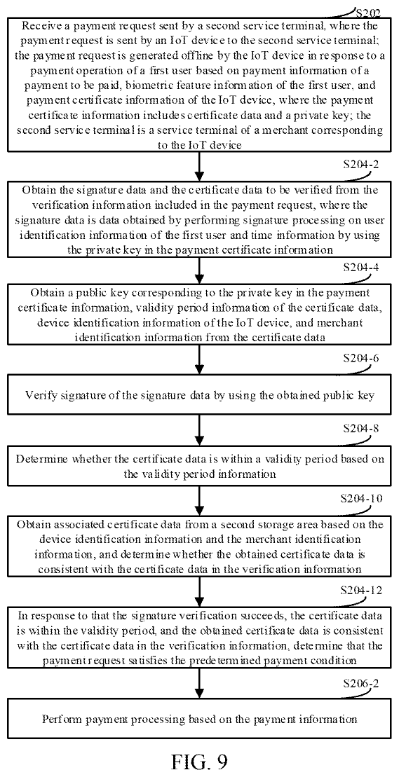

Further, when receiving the payment request, the first service terminal verifies the signature data and the validity period of the certificate data in the payment request, so as to ensure payment security. For example, as shown in FIG. 9, step S204 includes:

Step S204-2: Obtain the signature data and the certificate data to be verified from the verification information included in the payment request, where the signature data is data obtained by performing signature processing on user identification information of the first user and time information by using the private key in the payment certificate information.

Step S204-4: Obtain a public key corresponding to the private key in the payment certificate information, validity period information of the certificate data, device identification information of the IoT device, and merchant identification information from the certificate data.

Step S204-6: Verify signature of the signature data by using the obtained public key.

Step S204-8: Determine whether the certificate data is within a validity period based on the validity period information.

To avoid a delay in sending the payment request to the first service terminal due to a network factor, where the delayed time causes the certificate data to expire, thereby causing payment failure, in one or more embodiments of the present specification, time window information is predetermined, and the first service terminal determines whether the certificate data is within the validity period based on the time window information and the obtained validity period information. For example, the first service terminal obtains the current time and determines whether the current time is within the time corresponding to the validity period information. In response to the current time being within the time corresponding to the validity period information, the first service terminal determines that the certificate data is within the validity period. In response to the current time not being within the time corresponding to the validity period information, the first service terminal adds the time corresponding to the validity period information to the duration corresponding to the predetermined time window information, and determines the obtained time as a validity period threshold. In addition, the first service terminal determines whether the current time is within the validity period threshold. In response to the current time being within the validity period threshold, the first service terminal determines that the certificate data is within the validity period. In response to the current time not being within the validity period threshold, the first service terminal determines that the certificate data is not within the validity period.

In some examples, the time corresponding to the validity period information is 23:59 on Jun. 1, 2020, the duration corresponding to the predetermined time window information is 24 hours, and the current time obtained by the first service terminal is 9:30 on Jun. 2, 2020. In this case, it is determined that the current time 9:30 on Jun. 2, 2020 is not within the time 23:59 on Jun. 1, 2020 corresponding to the validity period information, and the time 23:59 on Jun. 1, 2020 corresponding to the validity period information is increased by the duration of 24 hours to obtain the validity period threshold 23:59 on Jun. 2, 2020. The current time 9:30 on Jun. 2, 2020 is within the validity period threshold, and it is determined that the certificate data is within the validity period.

Step S204-10: Obtain associated certificate data from a second storage area based on the device identification information and the merchant identification information, and determine whether the obtained certificate data is consistent with the certificate data in the verification information.

Step S204-12: In response to the signature verification succeeding, the certificate data being within the validity period, and the obtained certificate data being consistent with the certificate data in the verification information, determine that the payment request satisfies the predetermined payment condition.

The execution order of step S204-6 to step S204-10 is not limited to the previous order, and these steps can be interchanged with one another.

Corresponding to step S204-2 to step S204-12, as shown in FIG. 9, step S206 includes the following step S206-2:

Step S206-2: Perform payment processing based on the payment information.

When the signature data in the payment request is verified, and the private key for signature processing is held by the IoT device only. This can ensure that the payment request is sent by the corresponding IoT device. Verifying the validity period of the certificate data avoids an illegal operation of the stealer based on invalid certificate data due to leakage of certificate data. The certificate data is compared with the certificate data stored in the IoT device to implement a strong association between the certificate data and the IoT device and the merchant, avoiding trouble and loss caused by forging of certificate data by others.

Further, to ensure the payment function of the IoT device, the IoT device can apply to the first service terminal for updating the certificate data when determining that the validity period of the certificate data expires. Correspondingly, the method further includes: receiving a certificate update request sent by the IoT device, where the certificate update request includes certificate data to be updated; in response to determining that the certificate data satisfies a predetermined update condition, performing update processing to obtain new certificate data, and sending the new certificate data to the IoT device.

The determining that the certificate data satisfies the predetermined update condition includes: obtaining the validity period information from the certificate data and obtaining the current time, and determining whether the validity period of the certificate data expires based on the obtained validity period information and the current time; in response to the validity period of the certificate data not being expired, determining that the certificate data does not satisfy the predetermined update condition; in response to the validity period of the certificate data having expired, obtaining the device identification information of the IoT device and the merchant identification information from the certificate data, obtaining the associated certificate data from the second storage area based on the device identification information and the merchant identification information, and determining whether the obtained certificate data is consistent with the certificate data in the certificate update request; in response to the obtained certificate data being consistent with the certificate data in the certificate update request, determining that the certificate data satisfies the predetermined update condition; in response to the obtained certificate data being inconsistent with the certificate data in the certificate update request, determining that the certificate data does not satisfy the predetermined update condition, and sending update failure information to the IoT device.

Further, to ensure that payment processing is performed based on the correct payment account, in one or more embodiments of the present specification, as shown in FIG. 10, step S206 includes:

Step S206-4: Determine the payment account of the first user based on the user identification information obtained through signature verification, and perform payment processing based on the payment information and the determined payment account.

For example, the associated payment account is obtained from the association relationship between the user identification information and the payment account based on the user identification information. The association relationship between the user identification information and the payment account is an association relationship established when the first user applies for registration of the payment account.

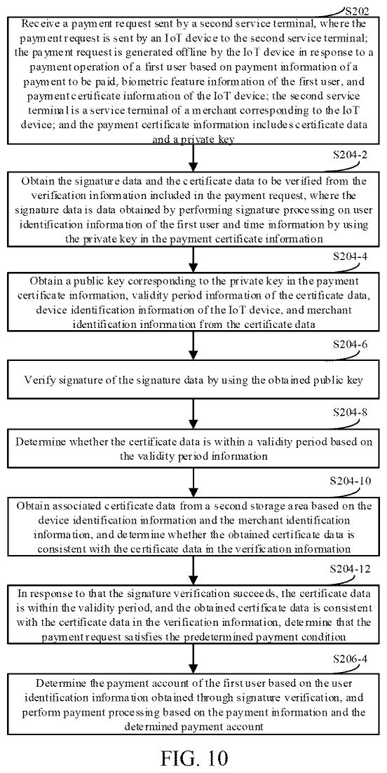

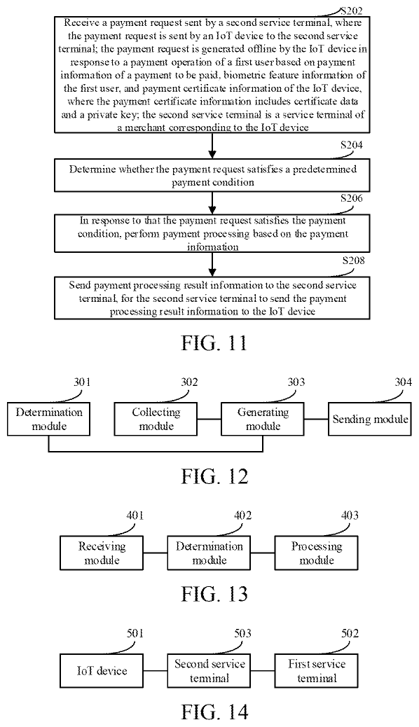

Further, to make the second service terminal and the IoT device aware of the payment result, as shown in FIG. 11, in one or more embodiments of the present specification, after step S206, the method further includes:

Step S208: Send payment processing result information to the second service terminal, for the second service terminal to send the payment processing result information to the IoT device.

Further, it is considered that when the first user uses the IoT device to perform payment, the biometric feature recognition payment service for the payment account may not have been subscribed to yet. To enable the first user to perform payment through the IoT device after successfully subscribing to the biometric feature recognition payment service, in one or more embodiments of the present specification, the method further includes: receiving a subscription request sent by the first user, and obtaining the biometric feature information of the first user based on the subscription request; performing subscription processing of the biometric feature recognition payment service for the payment account based on the biometric feature information; sending subscription success information to the first user, and sending the biometric feature information and the user identification information of the first user to the IoT device, for the IoT device to store the biometric feature information and the user identification information.

Further, in response to the first user having not registered a payment account, correspondingly, before the receiving the subscription request sent by the first user, the method further includes: receiving an account registration request sent by the first user, and performing account registration processing based on the account registration request to obtain the user identification information of the first user and the account information of the payment account; and sending account registration success information to the first user.

In one or more embodiments of the present specification, when the first service terminal receives the payment request sent by the second service terminal, in response to determining that the payment request satisfies the predetermined payment condition, the first service terminal performs payment processing based on the payment information included in the payment request. The payment request is generated offline by the IoT device in response to a payment operation of a first user based on payment information of a payment to be paid, biometric feature information of the first user, and payment certificate information, and is sent to the second service terminal. Therefore, offline generation of the payment request effectively avoids the problem of payment failure due to network instability or inaccessibility, and greatly improves payment efficiency. In addition, because the merchant cannot participate in the offline generation of the payment request, forging data by the merchant is effectively avoided. What's more, the first service terminal performs payment processing when determining that the payment request satisfies the predetermined payment condition, thereby effectively ensuring payment security.

Corresponding to the payment processing method described in FIG. 2 to FIG. 6, based on the same technical concept, one or more embodiments of the present specification further provide a payment processing apparatus, which is applied to an IoT device. FIG. 12 is a schematic module composition diagram illustrating a payment processing apparatus according to one or more embodiments of the present specification. The apparatus is configured to perform the payment processing method described in FIG. 2 to FIG. 6. As shown in FIG. 12, the apparatus includes: a determination module 301, configured to determine payment information of a payment to be paid in response to a payment operation of a first user; a collecting module 302, configured to collect to-be-verified biometric feature information of the first user; a generating module 303, configured to generate a payment request offline based on the payment information, the biometric feature information, and payment certificate information of the IoT device obtained in advance from a first service terminal, where the first service terminal is a service terminal corresponding to a payment application of the first user, and the payment certificate information includes certificate data and a private key; and a sending module 304, configured to send the payment request to a second service terminal, for the second service terminal to send the payment request to the first service terminal, and for the first service terminal to perform payment processing based on the payment information and a payment account of the payment application in response to the first service terminal determining that the payment request satisfies a predetermined payment condition, where the second service terminal is a service terminal of a merchant corresponding to the IoT device.

In response to the payment operation of the first user, the payment processing apparatus provided in one or more embodiments of the present specification generates the payment request offline based on the collected biometric feature information of the first user and the payment certificate information obtained in advance from the first service terminal, and sends the payment request to the first service terminal through the second service terminal, for the first service terminal to perform payment processing when determining that the payment request satisfies the predetermined payment condition. Therefore, offline generation of the payment request effectively avoids the problem of payment failure due to network instability or inaccessibility, and greatly improves payment efficiency. In addition, because the merchant cannot participate in the offline generation of the payment request, forging data by the merchant is effectively avoided. What's more, the IoT device generates the payment request based on the payment certificate information obtained from the first service terminal, etc., and the first service terminal performs payment processing when determining that the payment request satisfies the predetermined payment condition, thereby effectively ensuring payment security.

According to some implementations, the generating module 303 is configured to obtain user identification information of the first user offline based on the biometric feature information; perform signature processing on the user identification information and time information of current time based on the private key to obtain signature data; generate verification information to be verified based on the signature data and the certificate data; generate the payment request based on the verification information and the payment information; and display payment success information.

According to some implementations, the generating module 303 is configured to perform offline matching processing between the biometric feature information of the first user and biometric feature information stored in a first storage area; and in response to the offline matching processing succeeding, obtain user identification information associated with biometric feature information stored in the first storage area that matches with the biometric feature information of the first user, and determine the obtained user identification information as the user identification information of the first user.

According to some implementations, the apparatus further includes an acquisition module; and the acquisition module is configured to obtain, from the first service terminal and at a predetermined time interval, biometric feature information and user identification information of a user who has subscribed to a biometric feature recognition payment service; and store, in the first storage area, the obtained biometric feature information and the obtained user identification information of the first user as associated with one another.

According to some implementations, the apparatus further includes a display module, a receiving module, and a storage module; the display module is configured to: in response to the offline matching processing failing, display prompt information to prompt the first user to subscribe to a biometric feature recognition payment service for the payment account; the receiving module is configured to receive user identification information and biometric feature information of the first user sent by the first service terminal, where the user identification information and the biometric feature information are determined by the first service terminal based on a request sent by the first user for subscribing to a biometric feature recognition payment service; and the storage module is configured to store, in the first storage area, the biometric feature information and the user identification information of the first user as associated with one another.

According to some implementations, the sending module 304 is configured to: before the determining the payment information of the payment to be paid and the collecting the to-be-verified biometric feature information of the first user, send a device registration request to the first service terminal in response to a registration operation of the merchant, where the device registration request includes device identification information of the IoT device and merchant identification information of the merchant, for the first service terminal to allocate a public-private key pair to the IoT device, and generate the certificate data based on the device identification information, the merchant identification information, and the public key in the public-private key pair; and determine the certificate data and the private key as the payment certificate information of the IoT device, and send the payment certificate information to the IoT device; the receiving module is further configured to receive the payment certificate information sent by the first service terminal; and the storage module is configured to store the payment certificate information.

According to some implementations, the sending module 304 is configured to: in response to determining that a validity period of the certificate data expires, send a certificate update request to the first service terminal based on the certificate data, for the first service terminal to perform certificate update processing, and send updated new certificate data to the IoT device; and the receiving module is further configured to receive the new certificate data sent by the IoT device.

According to some implementations, the receiving module is further configured to: after the sending module 304 sends the payment request to a second service terminal, receive payment result information sent by the second service terminal, where the payment result information is information sent to the second service terminal after the first service terminal has performed the payment processing.

In response to the payment operation of the first user, the payment processing apparatus provided in one or more embodiments of the present specification generates the payment request offline based on the collected biometric feature information of the first user and the payment certificate information obtained in advance from the first service terminal, and sends the payment request to the first service terminal through the second service terminal, for the first service terminal to perform payment processing when determining that the payment request satisfies the predetermined payment condition. Therefore, offline generation of the payment request effectively avoids the problem of payment failure due to network instability or inaccessibility, and greatly improves payment efficiency. In addition, because the merchant cannot participate in the offline generation of the payment request, forging data by the merchant is effectively avoided. What's more, the IoT device generates the payment request based on the payment certificate information obtained from the first service terminal, etc., and the first service terminal performs payment processing when determining that the payment request satisfies the predetermined payment condition, thereby effectively ensuring payment security.

It should be noted that the embodiments of the payment processing apparatus in the present specification are based on the same inventive concept as the embodiments of the payment processing method in the present specification. Therefore, for specific implementation of the embodiments of the payment processing apparatus, reference can be made to the previous corresponding implementation of the payment processing method, and repeated parts are omitted for simplicity.

Further, corresponding to the payment processing method described in FIG. 7 to FIG. 11, based on the same technical concept, one or more embodiments of the present specification further provide another payment processing apparatus, which is applied to a first service terminal corresponding to a payment application. FIG. 13 is a schematic module composition diagram illustrating another payment processing apparatus according to one or more embodiments of the present specification. The apparatus is configured to perform the payment processing method described in FIG. 7 to FIG. 11. As shown in FIG. 13, the apparatus includes: a receiving module 401, configured to receive a payment request sent by a second service terminal, where the payment request is sent by an IoT device to the second service terminal; the payment request is generated offline by the IoT device in response to a payment operation of a first user based on payment information of a payment to be paid and payment certificate information of the IoT, where the payment certificate information includes certificate data and a private key; the second service terminal is a service terminal of a merchant corresponding to the IoT device; a determination module 402, configured to determine whether the payment request satisfies a predetermined payment condition; and a processing module 403, configured to: in response to the determination module determining that the payment request satisfies the payment condition, perform payment processing based on the payment information.

When the payment processing apparatus provided in one or more embodiments of the present specification receives the payment request sent by the second service terminal, in response to determining that the payment request satisfies the predetermined payment condition, the payment processing apparatus performs payment processing based on the payment information included in the payment request. The payment request is generated offline by the IoT device in response to a payment operation of a first user based on payment information of a payment to be paid, biometric feature information of the first user, and payment certificate information, and is sent to the second service terminal. Therefore, offline generation of the payment request effectively avoids the problem of payment failure due to network instability or inaccessibility, and greatly improves payment efficiency. In addition, because the merchant cannot participate in the offline generation of the payment request, forging data by the merchant is effectively avoided. What's more, the first service terminal performs payment processing when determining that the payment request satisfies the predetermined payment condition, thereby effectively ensuring payment security.

According to some implementations, the payment request includes verification information to be verified; the determination module 402 is configured to obtain signature data to be verified and the certificate data from the verification information, where the signature data is data obtained by performing signature processing on user identification information of the first user and time information by using the private key; obtain a public key corresponding to the private key, validity period information of the certificate data, device identification information of the IoT device, and merchant identification information of the merchant from the certificate data; verify signature of the signature data by using the obtained public key; determine whether the certificate data is within a validity period based on the validity period information; obtain associated certificate data from a second storage area based on the device identification information and the merchant identification information, and determine whether the obtained certificate data is consistent with the certificate data in the verification information; and in response to the signature verification succeeding, the certificate data is within the validity period, and the obtained certificate data is consistent with the certificate data in the verification information, determine that the payment request satisfies the predetermined payment condition.

According to some implementations, the processing module 403 is configured to determine a payment account of the first user based on the user identification information obtained through the signature verification; and perform payment processing based on the payment information and the payment account.

According to some implementations, the apparatus further includes a registration module, a sending module, and a storage module; the receiving module 401 is further configured to: before the receiving the payment request sent by the second service terminal, receive a device registration request sent by the IoT device, where the device registration request includes device identification information of the IoT device and merchant identification information of the merchant; the registration module is configured to allocate a public-private key pair to the IoT device, and determine validity period information of certificate data to be generated; and generate the certificate data based on the device identification information, the merchant identification information, the public key in the public-private key pair, and the validity period information; the sending module is configured to determine the certificate data and the private key in the public-private key pair as the payment certificate information of the IoT device, and send the payment certificate information to the IoT device; and the storage module is configured to store, in a second storage area, the certificate data, the device identification information, and the merchant identification information as associated with one another.

According to some implementations, the apparatus further includes an update module; the receiving module 401 is further configured to receive a certificate update request sent by the IoT device, where the certificate update request includes certificate data to be updated; and the update module is configured to: in response to determining that the certificate data satisfies a predetermined update condition, perform update processing to obtain new certificate data; and send the new certificate data to the IoT device.

According to some implementations, the apparatus further includes a sending module; and the sending module is configured to: after the processing module 403 performs the payment processing based on the payment information, send payment processing result information to the second service terminal, for the second service terminal to send the payment processing result information to the IoT device.

According to some implementations, the apparatus further includes a subscription module; the receiving module 401 is further configured to receive a subscription request sent by the first user, and obtain the biometric feature information of the first user based on the subscription request; and the subscription module is configured to perform subscription processing of a biometric feature recognition payment service for a corresponding payment account based on the biometric feature information; and send subscription success information to the first user, and send the biometric feature information and the user identification information to the IoT device, for the IoT device to store the biometric feature information and the user identification information.

When the payment processing apparatus provided in one or more embodiments of the present specification receives the payment request sent by the second service terminal, in response to determining that the payment request satisfies the predetermined payment condition, the payment processing apparatus performs payment processing based on the payment information included in the payment request. The payment request is generated offline by the IoT device in response to a payment operation of a first user based on payment information of a payment to be paid, biometric feature information of the first user, and payment certificate information, and is sent to the second service terminal. Therefore, offline generation of the payment request effectively avoids the problem of payment failure due to network instability or inaccessibility, and greatly improves payment efficiency. In addition, because the merchant cannot participate in the offline generation of the payment request, forging data by the merchant is effectively avoided. What's more, the first service terminal performs payment processing when determining that the payment request satisfies the predetermined payment condition, thereby effectively ensuring payment security.

It should be noted that the embodiments of the payment processing apparatus in the present specification are based on the same inventive concept as the embodiments of the payment processing method in the present specification. Therefore, for specific implementation of the embodiments of the payment processing apparatus, reference can be made to the previous implementation of the payment processing method, and repeated parts are omitted for simplicity.

Further, corresponding to the payment processing method described previously, based on the same technical concept, one or more embodiments of the present specification further provide a payment processing system. FIG. 14 is a schematic composition diagram illustrating a payment processing system according to one or more embodiments of the present specification. As shown in FIG. 14, the system includes an IoT device 501, a first service terminal 502, and a second service terminal 503. The first service terminal 502 is a service terminal corresponding to a payment application, and the second service terminal 503 is a service terminal of a merchant corresponding to the IoT device 501.

The IoT device 501 is configured to determine payment information of a payment to be paid in response to a payment operation of a first user, and collect to-be-verified biometric feature information of the first user; generate a payment request offline based on the payment information, the biometric feature information, and payment certificate information of the IoT device 501 obtained in advance from the first service terminal 502; and send the payment request to the second service terminal 503, where the payment certificate information includes certificate data and a private key.

The second service terminal 503 is configured to receive the payment request sent by the IoT device 501, and send the payment request to the first service terminal 502.

The first service terminal 502 is configured to determine whether the received payment request satisfies a predetermined payment condition, and in response to the payment request satisfying the predetermined payment condition, perform payment processing based on the payment information.

According to the payment processing system provided in one or more embodiments of the present specification, in response to the payment operation of the first user, the IoT device generates the payment request offline based on the collected biometric feature information of the first user and the payment certificate information obtained in advance from the first service terminal, and sends the payment request to the first service terminal through the second service terminal, for the first service terminal to perform payment processing when determining that the payment request satisfies the predetermined payment condition. Therefore, offline generation of the payment request effectively avoids the problem of payment failure due to network instability or inaccessibility, and greatly improves payment efficiency. In addition, because the merchant cannot participate in the offline generation of the payment request, forging data by the merchant is effectively avoided. What's more, the IoT device generates the payment request based on the payment certificate information obtained from the first service terminal, etc., and the first service terminal performs payment processing when determining that the payment request satisfies the predetermined payment condition, thereby effectively ensuring payment security.

It should be noted that the embodiments of the payment processing system in the present specification are based on the same inventive concept as the embodiments of the payment processing method in the present specification. Therefore, for specific implementation of the embodiments of the payment processing system, reference can be made to the previous corresponding implementation of the payment processing method, and repeated parts are omitted for simplicity.

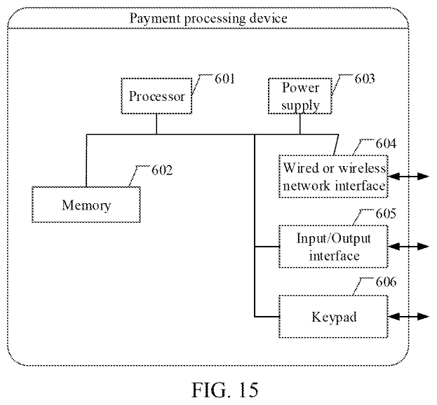

Further, corresponding to the payment processing method described previously, based on the same technical concept, one or more embodiments of the present specification further provide a payment processing device. The device is configured to perform the previous payment processing method. FIG. 15 is a schematic structural diagram illustrating a payment processing device according to one or more embodiments of the present specification.

As shown in FIG. 15, the payment processing device can differ greatly due to a difference in configuration or performance, and can include one or more processors 601 and one or more memories 602. The memory 602 can store one or more applications or data. The memory 602 can be a temporary storage or a persistent storage. The application stored in the memory 602 can include one or more modules (not shown in the figure), and a module can include a series of computer-executable instructions in the payment processing device. Still further, the processor 601 can be configured to communicate with the memory 602 to execute a series of computer-executable instructions in the memory 602 on the payment processing device. The payment processing device can further include one or more power supplies 603, one or more wired or wireless network interfaces 604, one or more input/output interfaces 605, one or more keypads 606, etc.

In some specific embodiments, the payment processing device includes a memory and one or more programs, where the one or more programs are stored in the memory, and the one or more programs can include one or more modules, and a module can include a series of computer-executable instructions in the payment processing device. One or more processors are configured to execute the computer-executable instructions included in the one or more programs to perform the following operations: determining payment information of a payment to be paid in response to a payment operation of a first user, and collecting to-be-verified biometric feature information of the first user; generating a payment request offline based on the payment information, the biometric feature information, and payment certificate information of the IoT device obtained in advance from a first service terminal, where the first service terminal is a service terminal corresponding to a payment application of the first user, and the payment certificate information includes certificate data and a private key; and sending the payment request to a second service terminal, for the second service terminal to send the payment request to the first service terminal, and for the first service terminal to perform payment processing based on the payment information and a payment account of the payment application in response to the first service terminal determining that the payment request satisfies a predetermined payment condition, where the second service terminal is a service terminal of a merchant corresponding to the IoT device.

In response to the payment operation of the first user, the payment processing device provided in one or more embodiments of the present specification generates the payment request offline based on the collected biometric feature information of the first user and the payment certificate information obtained in advance from the first service terminal, and sends the payment request to the first service terminal through the second service terminal, for the first service terminal to perform payment processing when determining that the payment request satisfies the predetermined payment condition. Therefore, offline generation of the payment request effectively avoids the problem of payment failure due to network instability or inaccessibility, and greatly improves payment efficiency. In addition, because the merchant cannot participate in the offline generation of the payment request, forging data by the merchant is effectively avoided. What's more, the IoT device generates the payment request based on the payment certificate information obtained from the first service terminal, etc., and the first service terminal performs payment processing when determining that the payment request satisfies the predetermined payment condition, thereby effectively ensuring payment security.

According to some implementations, when the computer-executable instructions are executed, the generating the payment request offline based on the payment information, the biometric feature information, and the payment certificate information of the IoT device obtained in advance from the first service terminal includes: obtaining user identification information of the first user offline based on the biometric feature information; performing signature processing on the user identification information and time information of current time based on the private key to obtain signature data; generating verification information to be verified based on the signature data and the certificate data; generating the payment request based on the verification information and the payment information; and displaying payment success information.

According to some implementations, when the computer-executable instructions are executed, the obtaining the user identification information of the first user offline based on the biometric feature information includes: performing offline matching processing between the biometric feature information of the first user and biometric feature information stored in a first storage area; and in response to the offline matching processing succeeding, obtaining user identification information associated with biometric feature information stored in the first storage area that matches with the biometric feature information of the first user, and determining the obtained user identification information as the user identification information of the first user.

According to some implementations, when the computer-executable instructions are executed, the method further includes: obtaining, from the first service terminal and at a predetermined time interval, biometric feature information and user identification information of a user who has subscribed to a biometric feature recognition payment service; and storing, in the first storage area, the obtained biometric feature information and the obtained user identification information of the user as associated with one another.

According to some implementations, when the computer-executable instructions are executed, the method further includes: in response to the offline matching processing failing, displaying prompt information to prompt the first user to subscribe to a biometric feature recognition payment service for the payment account; receiving user identification information and biometric feature information of the first user sent by the first service terminal, where the user identification information and the biometric feature information are determined by the first service terminal based on a request sent by the first user for subscribing to a biometric feature recognition payment service; and storing, in the first storage area, the biometric feature information and the user identification information of the first user as associated with one another.

According to some implementations, when the computer-executable instructions are executed, before the determining the payment information of the payment to be paid in response to the payment operation of the first user, and the collecting the to-be-verified biometric feature information of the first user, the method further includes: sending a device registration request to the first service terminal in response to a registration operation of the merchant, where the device registration request includes device identification information of the IoT device and merchant identification information of the merchant, for the first service terminal to allocate a public-private key pair to the IoT device, and generate the certificate data based on the device identification information, the merchant identification information, and the public key in the public-private key pair; and determine the certificate data and the private key as the payment certificate information of the IoT device, and send the payment certificate information to the IoT device; and storing the received payment certificate information sent by the first service terminal.

According to some implementations, when the computer-executable instructions are executed, the method further includes: in response to determining that a validity period of the certificate data expires, sending a certificate update request to the first service terminal based on the certificate data, for the first service terminal to perform certificate update processing, and send updated new certificate data to the IoT device; and receiving the new certificate data sent by the IoT device.

According to some implementations, when the computer-executable instructions are executed, after the sending the payment request to the second service terminal, the method further includes: receiving payment result information sent by the second service terminal, where the payment result information is information sent to the second service terminal after the first service terminal has performed the payment processing.

In response to the payment operation of the first user, the payment processing device provided in one or more embodiments of the present specification generates the payment request offline based on the collected biometric feature information of the first user and the payment certificate information obtained in advance from the first service terminal, and sends the payment request to the first service terminal through the second service terminal, for the first service terminal to perform payment processing when determining that the payment request satisfies the predetermined payment condition. Therefore, offline generation of the payment request effectively avoids the problem of payment failure due to network instability or inaccessibility, and greatly improves payment efficiency. In addition, because the merchant cannot participate in the offline generation of the payment request, forging data by the merchant is effectively avoided. What's more, the IoT device generates the payment request based on the payment certificate information obtained from the first service terminal, etc., and the first service terminal performs payment processing when determining that the payment request satisfies the predetermined payment condition, thereby effectively ensuring payment security.

In some other specific embodiments, the payment processing device includes a memory and one or more programs, where the one or more programs are stored in the memory, and the one or more programs can include one or more modules, and a module can include a series of computer-executable instructions in the payment processing device. One or more processors are configured to execute the computer-executable instructions included in the one or more programs to perform the following operations: receiving a payment request sent by a second service terminal, where the payment request is sent by an IoT device to the second service terminal; the payment request is generated offline by the IoT device in response to a payment operation of a first user based on payment information of a payment to be paid, biometric feature information of the first user, and payment certificate information of the IoT device, where the payment certificate information includes certificate data and a private key; the second service terminal is a service terminal of a merchant corresponding to the IoT device; determining whether the payment request satisfies a predetermined payment condition; and in response to the payment request satisfying the predetermined payment condition, performing payment processing based on the payment information.

When the payment processing device provided in one or more embodiments of the present specification receives the payment request sent by the second service terminal, in response to determining that the payment request satisfies the predetermined payment condition, the payment processing device performs payment processing based on the payment information included in the payment request. The payment request is generated offline by the IoT device in response to a payment operation of a first user based on payment information of a payment to be paid, biometric feature information of the first user, and payment certificate information, and is sent to the second service terminal. Therefore, offline generation of the payment request effectively avoids the problem of payment failure due to network instability or inaccessibility, and greatly improves payment efficiency. In addition, because the merchant cannot participate in the offline generation of the payment request, forging data by the merchant is effectively avoided. What's more, the first service terminal performs payment processing when determining that the payment request satisfies the predetermined payment condition, thereby effectively ensuring payment security.

According to some implementations, when the computer-executable instructions are executed, the payment request includes verification information to be verified; the determining whether the payment request satisfies the predetermined payment condition includes: obtaining signature data to be verified and the certificate data from the verification information, where the signature data is data obtained by performing signature processing on user identification information of the first user and time information by using the private key; obtaining a public key corresponding to the private key, validity period information of the certificate data, device identification information of the IoT device, and merchant identification information of the merchant from the certificate data; verifying signature of the signature data by using the obtained public key; determining whether the certificate data is within a validity period based on the validity period information; obtaining associated certificate data from a second storage area based on the device identification information and the merchant identification information, and determining whether the obtained certificate data is consistent with the certificate data in the verification information; and in response to the signature verification succeeding, the certificate data is within the validity period, and the obtained certificate data is consistent with the certificate data in the verification information, determining that the payment request satisfies the predetermined payment condition.

According to some implementations, when the computer-executable instructions are executed, the performing the payment processing based on the payment information includes: determining a payment account of the first user based on the user identification information obtained through the signature verification; and performing payment processing based on the payment information and the payment account.

According to some implementations, when the computer-executable instructions are executed, before the receiving the payment request sent by the second service terminal, the method further includes: receiving a device registration request sent by the IoT device, where the device registration request includes device identification information of the IoT device and merchant identification information of the merchant; allocating a public-private key pair to the IoT device, and determining validity period information of certificate data to be generated; generating the certificate data based on the device identification information, the merchant identification information, the public key in the public-private key pair, and the validity period information; determining the certificate data and the private key in the public-private key pair as the payment certificate information of the IoT device; sending the payment certificate information to the IoT device; and storing, in a second storage area, the certificate data, the device identification information, and the merchant identification information as associated with one another.

According to some implementations, when the computer-executable instructions are executed, the method further includes: receiving a certificate update request sent by the IoT device, where the certificate update request includes certificate data to be updated; in response to determining that the certificate data satisfies a predetermined update condition, performing update processing to obtain new certificate data; and sending the new certificate data to the IoT device.

According to some implementations, when the computer-executable instructions are executed, after the performing the payment processing based on the payment information, the method further includes: sending payment processing result information to the second service terminal, for the second service terminal to send the payment processing result information to the IoT device.

According to some implementations, when the computer-executable instructions are executed, the method further includes: receiving a subscription request sent by the first user, and obtaining the biometric feature information of the first user based on the subscription request; performing subscription processing of a biometric feature recognition payment service for a corresponding payment account based on the biometric feature information; and sending subscription success information to the first user, and sending the biometric feature information and the user identification information to the IoT device, for the IoT device to store the biometric feature information and the user identification information.

When the payment processing device provided in one or more embodiments of the present specification receives the payment request sent by the second service terminal, in response to determining that the payment request satisfies the predetermined payment condition, the payment processing device performs payment processing based on the payment information included in the payment request. The payment request is generated offline by the IoT device in response to a payment operation of a first user based on payment information of a payment to be paid, biometric feature information of the first user, and payment certificate information, and is sent to the second service terminal. Therefore, offline generation of the payment request effectively avoids the problem of payment failure due to network instability or inaccessibility, and greatly improves payment efficiency. In addition, because the merchant cannot participate in the offline generation of the payment request, forging data by the merchant is effectively avoided. What's more, the first service terminal performs payment processing when determining that the payment request satisfies the predetermined payment condition, thereby effectively ensuring payment security.

It should be noted that the embodiments of the payment processing device in the present specification are based on the same inventive concept as the embodiments of the payment processing method in the present specification. Therefore, for specific implementation of the embodiments of the payment processing device, reference can be made to the previous corresponding implementation of the payment processing method, and repeated parts are omitted for simplicity.

Further, corresponding to the payment processing method described previously, based on the same technical concept, one or more embodiments of the present specification further provide a storage medium, configured to store a computer-executable instruction; in some specific embodiments, the storage medium can be a USB flash drive, an optical disc, a hard disk, etc., and the computer-executable instruction stored in the storage medium can be executed by a processor to implement the following procedure: determining payment information of a payment to be paid in response to a payment operation of a first user, and collecting to-be-verified biometric feature information of the first user; generating a payment request offline based on the payment information, the biometric feature information, and payment certificate information of the IoT device obtained in advance from a first service terminal, where the first service terminal is a service terminal corresponding to a payment application of the first user, and the payment certificate information includes certificate data and a private key; and sending the payment request to a second service terminal, for the second service terminal to send the payment request to the first service terminal, and for the first service terminal to perform payment processing based on the payment information and a payment account of the payment application in response to the first service terminal determining that the payment request satisfies a predetermined payment condition, where the second service terminal is a service terminal of a merchant corresponding to the IoT device.

When the computer-executable instructions stored in the storage medium provided in one or more embodiments of the present specification are executed by a processor, in response to the payment operation of the first user, the processor generates the payment request offline based on the collected biometric feature information of the first user and the payment certificate information obtained in advance from the first service terminal, and sends the payment request to the first service terminal through the second service terminal, for the first service terminal to perform payment processing when determining that the payment request satisfies the predetermined payment condition. Therefore, offline generation of the payment request effectively avoids the problem of payment failure due to network instability or inaccessibility, and greatly improves payment efficiency. In addition, because the merchant cannot participate in the offline generation of the payment request, forging data by the merchant is effectively avoided. What's more, the IoT device generates the payment request based on the payment certificate information obtained from the first service terminal, etc., and the first service terminal performs payment processing when determining that the payment request satisfies the predetermined payment condition, thereby effectively ensuring payment security.

According to some implementations, when the computer-executable instructions stored in the storage medium are executed by a processor, the generating the payment request offline based on the payment information, the biometric feature information, and the payment certificate information of the IoT device obtained in advance from the first service terminal includes: obtaining user identification information of the first user offline based on the biometric feature information; performing signature processing on the user identification information and time information of current time based on the private key to obtain signature data; generating verification information to be verified based on the signature data and the certificate data; generating the payment request based on the verification information and the payment information; and displaying payment success information.

According to some implementations, when the computer-executable instructions stored in the storage medium are executed by a processor, the obtaining the user identification information of the first user offline based on the biometric feature information includes: performing offline matching processing between the biometric feature information of the first user and biometric feature information stored in a first storage area; and in response to the offline matching processing succeeding, obtaining user identification information associated with biometric feature information stored in the first storage area that matches with the biometric feature information of the first user, and determining the obtained user identification information as the user identification information of the first user.

According to some implementations, when the computer-executable instructions stored in the storage medium are executed by a processor, the method further includes: obtaining, from the first service terminal and at a predetermined time interval, biometric feature information and user identification information of a user who has subscribed to a biometric feature recognition payment service; and storing, in the first storage area, the obtained biometric feature information and the obtained user identification information of the user as associated with one another.

According to some implementations, when the computer-executable instructions stored in the storage medium are executed by a processor, the method further includes: in response to the offline matching processing failing, displaying prompt information to prompt the first user to subscribe to a biometric feature recognition payment service for the payment account; receiving user identification information and biometric feature information of the first user sent by the first service terminal, where the user identification information and the biometric feature information are determined by the first service terminal based on a request sent by the first user for subscribing to a biometric feature recognition payment service; and storing, in the first storage area, the biometric feature information and the user identification information of the first user as associated with one another.

According to some implementations, when the computer-executable instructions stored in the storage medium are executed by a processor, before the determining the payment information of the payment to be paid in response to the payment operation of the first user, and the collecting the to-be-verified biometric feature information of the first user, the method further includes: sending a device registration request to the first service terminal in response to a registration operation of the merchant, where the device registration request includes device identification information of the IoT device and merchant identification information of the merchant, for the first service terminal to allocate a public-private key pair to the IoT device, and generate the certificate data based on the device identification information, the merchant identification information, and the public key in the public-private key pair; and determine the certificate data and the private key as the payment certificate information of the IoT device, and send the payment certificate information to the IoT device; and storing the received payment certificate information sent by the first service terminal.

According to some implementations, when the computer-executable instructions stored in the storage medium are executed by a processor, the method further includes: in response to determining that a validity period of the certificate data expires, sending a certificate update request to the first service terminal based on the certificate data, for the first service terminal to perform certificate update processing, and send updated new certificate data to the IoT device; and receiving the new certificate data sent by the IoT device.

According to some implementations, when the computer-executable instructions stored in the storage medium are executed by a processor, after the sending the payment request to the second service terminal, the method further includes: receiving payment result information sent by the second service terminal, where the payment result information is information sent to the second service terminal after the first service terminal has performed the payment processing.

When the computer-executable instructions stored in the storage medium provided in one or more embodiments of the present specification are executed by a processor, in response to the payment operation of the first user, the processor generates the payment request offline based on the collected biometric feature information of the first user and the payment certificate information obtained in advance from the first service terminal, and sends the payment request to the first service terminal through the second service terminal, for the first service terminal to perform payment processing when determining that the payment request satisfies the predetermined payment condition. Therefore, offline generation of the payment request effectively avoids the problem of payment failure due to network instability or inaccessibility, and greatly improves payment efficiency. In addition, because the merchant cannot participate in the offline generation of the payment request, forging data by the merchant is effectively avoided. What's more, the IoT device generates the payment request based on the payment certificate information obtained from the first service terminal, etc., and the first service terminal performs payment processing when determining that the payment request satisfies the predetermined payment condition, thereby effectively ensuring payment security.

In some specific embodiments, the storage medium can be a USB flash drive, an optical disc, a hard disk, etc., and the computer-executable instruction stored in the storage medium can be executed by a processor to implement the following procedure: receiving a payment request sent by a second service terminal, where the payment request is sent by an IoT device to the second service terminal; the payment request is generated offline by the IoT device in response to a payment operation of a first user based on payment information of a payment to be paid, biometric feature information of the first user, and payment certificate information of the IoT device, where the payment certificate information includes certificate data and a private key; the second service terminal is a service terminal of a merchant corresponding to the IoT device; determining whether the payment request satisfies a predetermined payment condition; and in response to the payment request satisfying the predetermined payment condition, performing payment processing based on the payment information.

When the computer-executable instructions stored in the storage medium provided in one or more embodiments of the present specification are executed by a processor, the processor receives the payment request sent by the second service terminal, in response to determining that the payment request satisfies the predetermined payment condition, the processor performs payment processing based on the payment information included in the payment request. The payment request is generated offline by the IoT device in response to a payment operation of a first user based on payment information of a payment to be paid, biometric feature information of the first user, and payment certificate information, and is sent to the second service terminal. Therefore, offline generation of the payment request effectively avoids the problem of payment failure due to network instability or inaccessibility, and greatly improves payment efficiency. In addition, because the merchant cannot participate in the offline generation of the payment request, forging data by the merchant is effectively avoided. What's more, the first service terminal performs payment processing when determining that the payment request satisfies the predetermined payment condition, thereby effectively ensuring payment security.

According to some implementations, when the computer-executable instructions stored in the storage medium are executed by a processor, the payment request includes verification information to be verified; the determining whether the payment request satisfies the predetermined payment condition includes: obtaining signature data to be verified and the certificate data from the verification information, where the signature data is data obtained by performing signature processing on user identification information of the first user and time information by using the private key; obtaining a public key corresponding to the private key, validity period information of the certificate data, device identification information of the IoT device, and merchant identification information of the merchant from the certificate data; verifying signature of the signature data by using the obtained public key; determining whether the certificate data is within a validity period based on the validity period information; obtaining associated certificate data from a second storage area based on the device identification information and the merchant identification information, and determining whether the obtained certificate data is consistent with the certificate data in the verification information; and in response to the signature verification succeeding, the certificate data is within the validity period, and the obtained certificate data is consistent with the certificate data in the verification information, determining that the payment request satisfies the predetermined payment condition.

According to some implementations, when the computer-executable instructions stored in the storage medium are executed by a processor, the performing the payment processing based on the payment information includes: determining a payment account of the first user based on the user identification information obtained through the signature verification; and performing payment processing based on the payment information and the payment account.

According to some implementations, when the computer-executable instructions stored in the storage medium are executed by a processor, before the receiving the payment request sent by the second service terminal, the method further includes: receiving a device registration request sent by the IoT device, where the device registration request includes device identification information of the IoT device and merchant identification information of the merchant; allocating a public-private key pair to the IoT device, and determining validity period information of certificate data to be generated; generating the certificate data based on the device identification information, the merchant identification information, the public key in the public-private key pair, and the validity period information; determining the certificate data and the private key in the public-private key pair as the payment certificate information of the IoT device; sending the payment certificate information to the IoT device; and storing, in a second storage area, the certificate data, the device identification information, and the merchant identification information as associated with one another.

According to some implementations, when the computer-executable instructions stored in the storage medium are executed by a processor, the method further includes: receiving a certificate update request sent by the IoT device, where the certificate update request includes certificate data to be updated; in response to determining that the certificate data satisfies a predetermined update condition, performing update processing to obtain new certificate data; and sending the new certificate data to the IoT device.

According to some implementations, when the computer-executable instructions stored in the storage medium are executed by a processor, after the performing the payment processing based on the payment information, the method further includes: sending payment processing result information to the second service terminal, for the second service terminal to send the payment processing result information to the IoT device.

According to some implementations, when the computer-executable instructions stored in the storage medium are executed by a processor, the method further includes: receiving a subscription request sent by the first user, and obtaining the biometric feature information of the first user based on the subscription request; performing subscription processing of a biometric feature recognition payment service for a corresponding payment account based on the biometric feature information; and sending subscription success information to the first user, and sending the biometric feature information and the user identification information to the IoT device, for the IoT device to store the biometric feature information and the user identification information.

When the computer-executable instructions stored in the storage medium provided in one or more embodiments of the present specification are executed by a processor, the processor receives the payment request sent by the second service terminal, in response to determining that the payment request satisfies the predetermined payment condition, the processor performs payment processing based on the payment information included in the payment request. The payment request is generated offline by the IoT device in response to a payment operation of a first user based on payment information of a payment to be paid, biometric feature information of the first user, and payment certificate information, and is sent to the second service terminal. Therefore, offline generation of the payment request effectively avoids the problem of payment failure due to network instability or inaccessibility, and greatly improves payment efficiency. In addition, because the merchant cannot participate in the offline generation of the payment request, forging data by the merchant is effectively avoided. What's more, the first service terminal performs payment processing when determining that the payment request satisfies the predetermined payment condition, thereby effectively ensuring payment security.

It should be noted that the embodiments of the storage medium in the present specification are based on the same inventive concept as the embodiments of the payment processing method in the present specification. Therefore, for specific implementation of the embodiments of the storage medium, reference can be made to the previous corresponding implementation of the payment processing method, and repeated parts are omitted for simplicity.

The specific embodiments of the present specification are described previously. Other embodiments fall within the scope of the appended claims. In some situations, the actions or steps described in the claims can be performed in an order different from the order in the embodiments and the desired results can still be achieved. In addition, the process depicted in the accompanying drawings does not necessarily need a particular execution order to achieve the desired results. In some implementations, multi-tasking and concurrent processing are feasible or may be advantageous.

In the 1990s, whether a technical improvement is a hardware improvement (for example, an improvement to a circuit structure, such as a diode, a transistor, or a switch) or a software improvement (an improvement to a method procedure) can be clearly distinguished. However, as technologies develop, the current improvement for many method procedures can be considered as a direct improvement of a hardware circuit structure. A designer usually programs an improved method procedure to a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the programmable logic device is determined by a first user through device programming. The designer performs programming to “integrate” a digital system to a PLD without requesting a chip manufacturer to design and produce an application-specific integrated circuit chip. In addition, at present, instead of manually manufacturing an integrated chip, this type of programming is mostly implemented by using “logic compiler” software. The programming is similar to a software compiler used to develop and write a program. Original code needs to be written in a particular programming language for compilation. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The very-high-speed integrated circuit hardware description language (VHDL) and Verilog are most commonly used. A person skilled in the art should also understand that a hardware circuit that implements a logical method procedure can be readily obtained once the method procedure is logically programmed by using the several described hardware description languages and is programmed into an integrated circuit.

A controller can be implemented by using any appropriate method. For example, the controller can be a microprocessor or a processor, or a computer-readable medium that stores computer-readable program code (such as software or firmware) that can be executed by the microprocessor or the processor, a logic gate, a switch, an application-specific integrated circuit (ASIC), a programmable logic controller, or a built-in microprocessor. Examples of the controller include but are not limited to the following microprocessors: ARC 625D, Atmel AT91SAM, Microchip PIC18F26K20, and Silicon Labs C8051F320. The memory controller can also be implemented as a part of the control logic of the memory. A person skilled in the art also knows that, in addition to implementing the controller by using the computer-readable program code, logic programming can be performed on method steps to allow the controller to implement the same function in forms of the logic gate, the switch, the application-specific integrated circuit, the programmable logic controller, and the built-in microcontroller. Therefore, the controller can be considered as a hardware component, and an apparatus configured to implement various functions in the controller can also be considered as a structure in the hardware component. Alternatively, the apparatus configured to implement various functions can even be considered as both a software module implementing the method and a structure in the hardware component.

The system, apparatus, module, or unit illustrated in the previous embodiments can be, for example, implemented by using a computer chip or an entity, or can be implemented by using a product having a certain function. A typical implementation device is a computer. For example, the computer can be a personal computer, a laptop computer, a cellular phone, a camera phone, a smart phone, a personal digital assistant, a media player, a navigation device, an e-mail device, a game console, a tablet computer, a wearable device, or any combination of these devices.

For ease of description, the previous apparatus is described by dividing functions into various units. Certainly, when the present specification is implemented, a function of a unit can be implemented in one or more pieces of software and/or hardware.

A person skilled in the art should understand that one or more embodiments of the present specification can be provided as a method, a system, or a computer program product. Therefore, one or more embodiments of the present specification can take the form of hardware only embodiments, software only embodiments, or embodiments with a combination of software and hardware. Moreover, the present specification can use a form of a computer program product that is implemented on one or more computer-usable storage media (including but not limited to a disk memory, a CD-ROM, an optical memory, etc.) that include computer-usable program code.

The present specification is described with reference to the flowcharts and/or block diagrams of the method, the device (system), and the computer program product based on the embodiments of the present specification. It should be understood that computer program instructions can be used to implement a process and/or a block in the flowcharts and/or the block diagrams and a combination of a process and/or a block in the flowcharts and/or the block diagrams. These computer program instructions can be provided for a general-purpose computer, a dedicated computer, an embedded processor, or a processor of another programmable data processing device to generate a machine, so the instructions executed by the computer or the processor of the another programmable data processing device generate an apparatus for implementing a specific function in one or more processes in the flowcharts and/or in one or more blocks in the block diagrams.

These computer program instructions can be stored in a computer-readable memory that can instruct the computer or the another programmable data processing device to work in a specific way, so the instructions stored in the computer-readable memory generate an artifact that includes an instruction apparatus. The instruction apparatus implements a specific function in one or more processes in the flowcharts and/or in one or more blocks in the block diagrams.

These computer program instructions can alternatively be loaded onto the computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

In a typical configuration, a computing device includes one or more processors (CPUs), one or more input/output interfaces, one or more network interfaces, and one or more memories.

The memory can include a non-persistent memory, a random access memory (RAM), a non-volatile memory, and/or another form that are in a computer-readable medium, for example, a read-only memory (ROM) or a flash memory (flash RAM). The memory is an example of the computer-readable medium.

The computer readable medium includes a persistent and a non-persistent, a removable and a non-removable medium, which implement information storage by using any method or technology. Information may be a computer readable instruction, a data structure, a module of a program or other data. Examples of the computer storage medium include but are not limited to a phase change random access memory (PRAM), a static random access memory (SRAM), a dynamic random access memory (DRAM), another type of RAM, a ROM, an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, another magnetic storage device, or any other non-transmission medium. The computer storage medium can be used to store information accessible by a computing device. Based on the definition in the present specification, the computer-readable medium does not include transitory media such as a modulated data signal and carrier.

It should be further noted that terms “include,” “comprise” or any other variant thereof are intended to cover non-exclusive inclusion, so that processes, methods, products or devices that include a series of elements include not only those elements but also other elements that are not explicitly listed, or further include elements inherent to such processes, methods, products or devices. An element described by “includes a . . . ” further includes, without more constraints, another identical element in the process, method, product, or device that includes the element.

One or more embodiments of the present specification can be described in the general context of computer-executable instructions, for example, a program module. Generally, the program module includes a routine, a program, an object, a component, a data structure, etc., executing a specific task or implementing a specific abstract data type. One or more embodiments of the present specification can alternatively be practiced in distributed computing environments in which tasks are performed by remote processing devices that are connected through a communications network. In a distributed computing environment, the program module can be located in both local and remote computer storage media including storage devices.

The embodiments in the present specification are described in a progressive way. For same or similar parts of the embodiments, mutual references can be made to the embodiments. Each embodiment focuses on a difference from other embodiments. Particularly, a system embodiment is basically similar to a method embodiment, and therefore is described briefly. For related parts, reference can be made to related descriptions in the method embodiment.

The previous descriptions are merely embodiments of the present specification, and are not intended to limit the present specification. A person skilled in the art can make various modifications and changes to the present specification. Any modification, equivalent replacement, or improvement made without departing from the spirit and principle of the present specification shall fall within the scope of the claims in the present specification.

The various embodiments described above can be combined to provide further embodiments. Aspects of the embodiments can be modified, if necessary, to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A payment processing method, comprising:
determining, by an interne of things (IoT) device, payment information of a payment to be paid in response to a payment operation of a first user;
collecting, by the IoT device, biometric feature information of the first user;
generating, offline by the IoT device, a payment request based on the payment information, the biometric feature information, and payment certificate information of the IoT device obtained from a first service terminal, the first service terminal being a service terminal corresponding to a payment application of the first user, and the payment certificate information including certificate data and a private key; and
sending the payment request to a second service terminal, for the second service terminal to send the payment request to the first service terminal, and for the first service terminal to perform payment processing based on the payment information and a payment account of the payment application in response to the payment request satisfying a first payment condition, wherein the second service terminal is a service terminal of a merchant corresponding to the IoT device.

2. The method according to claim 1, wherein the generating the payment request offline based on the payment information, the biometric feature information, and the payment certificate information of the IoT device includes:
obtaining user identification information of the first user offline based on the biometric feature information;
performing signature processing on the user identification information and time information of a current time based on the private key to obtain signature data; and
generating the payment request based on the signature data, the certificate data, and the payment information.

3. The method according to claim 2, wherein the obtaining the user identification information of the first user offline based on the biometric feature information includes:
performing offline matching processing between the biometric feature information of the first user and stored biometric feature information stored in a first storage area; and
in response to the offline matching processing being successful, obtaining user identification information associated with stored biometric feature information that matches with the biometric feature information of the first user, and determining the user identification information as the user identification information of the first user.

4. The method according to claim 3, comprising:
obtaining, from the first service terminal and at a predetermined time interval, biometric feature information and user identification information of a user who has subscribed to a payment service; and
storing, in the first storage area, the biometric feature information and the user identification information of the user as associated with one another.

5. The method according to claim 3, comprising:
in response to the offline matching processing being not successful, displaying prompt information to prompt the first user to subscribe to a payment service for the payment account;
receiving user identification information and biometric feature information of the first user sent by the first service terminal, wherein the user identification information and the biometric feature information of the first user are determined by the first service terminal based on a request sent by the first user for subscribing to the payment service; and
storing, in the first storage area, the biometric feature information and the user identification information of the first user as associated with one another.

6. The method according to claim 1, comprising:
before the determining the payment information of the payment to be paid in response to the payment operation of the first user, and the collecting the biometric feature information of the first user,
sending a device registration request to the first service terminal in response to a registration operation of the merchant, the device registration request including device identification information of the IoT device and merchant identification information of the merchant, for the first service terminal to allocate a public-private key pair to the IoT device including the private key, and to generate the certificate data based on the device identification information, the merchant identification information, and a public key in the public-private key pair; and
receiving the certificate data and the private key sent by the first service terminal.

7. The method according to claim 1, further comprising:
in response to determining that a validity period of the certificate data expires, sending a certificate update request to the first service terminal based on the certificate data, for the first service terminal to perform certificate update processing, and to send updated certificate data to the IoT device; and
receiving the updated certificate data sent by the IoT device.

8. The method according to claim 1, comprising:
after the sending the payment request to the second service terminal,
receiving payment result information sent by the second service terminal, wherein the payment result information is information sent to the second service terminal after the first service terminal has performed the payment processing.

9. A payment processing method, comprising:
receiving, by a first service terminal corresponding to a payment application, a payment request sent by a second service terminal, the payment requesting including payment information of a payment to be paid;
determining whether the payment request satisfies a payment condition; and
in response to the payment request satisfying the payment condition, performing payment processing based on the payment information,
wherein:
the payment request is sent by an internet-of-things (IoT) device to the second service terminal;
the payment request is generated offline by the IoT device in response to a payment operation of a first user based on the payment information of the payment to be paid, biometric feature information of the first user, and payment certificate information of the IoT device;
the payment certificate information includes certificate data and a private key; and
the second service terminal is a service terminal of a merchant corresponding to the IoT device.

10. The method according to claim 9, wherein the determining whether the payment request satisfies the payment condition includes:
obtaining signature data and the certificate data from the payment request, wherein the signature data is generated by performing signature processing on user identification information of the first user and time information by using the private key;
obtaining a public key corresponding to the private key, validity period information of the certificate data, device identification information of the IoT device, and merchant identification information of the merchant from the certificate data;
verifying signature of the signature data by using the public key;
determining whether the certificate data is within a validity period based on the validity period information;
obtaining stored certificate data from a second storage area based on the device identification information and the merchant identification information, and determining whether the stored certificate data is consistent with the certificate data in the payment request; and
in response to the signature verification being successful, the certificate data being within the validity period, and the stored certificate data being consistent with the certificate data in the payment request, determining that the payment request satisfies the payment condition.

11. The method according to claim 10, wherein the performing payment processing based on the payment information includes:
determining a payment account of the first user based on the user identification information obtained through the verifying the signature; and
performing payment processing based on the payment information and the payment account.

12. The method according to claim 9, comprising: before the receiving the payment request sent by the second service terminal,
receiving a device registration request sent by the IoT device, wherein the device registration request includes device identification information of the IoT device and merchant identification information of the merchant;
allocating a public-private key pair to the IoT device including a public key and the private key, and determining validity period information of certificate data to be generated;
generating the certificate data based on the device identification information, the merchant identification information, the public key in the public-private key pair, and the validity period information;
determining the certificate data and the private key in the public-private key pair as the payment certificate information of the IoT device;
sending the payment certificate information to the IoT device; and
storing, in a second storage area, the certificate data, the device identification information, and the merchant identification information as associated with one another.

13. The method according to claim 9, comprising:
receiving a certificate update request sent by the IoT device, wherein the certificate update request includes certificate data to be updated;
in response to determining that the certificate data satisfies an update condition, performing update processing to obtain updated certificate data; and
sending the updated certificate data to the IoT device.

14. The method according to claim 9, comprising:
after the performing the payment processing based on the payment information,
sending payment processing result information to the second service terminal, for the second service terminal to send the payment processing result information to the IoT device.

15. The method according to claim 9, comprising:
receiving a subscription request sent by the first user, and obtaining the biometric feature information of the first user based on the subscription request;
performing subscription processing for a corresponding payment account based on the biometric feature information of the first user, the subscription processing generating user identification information of the first user; and
sending subscription success information to the first user, and sending the biometric feature information and user identification information of the first user to the IoT device, for the IoT device to store the biometric feature information and the user identification information.

16. A computing device, comprising a processor and a memory, the memory storing executable instructions, the executable instructions when executed by the processor enable the processor to implement acts including:
determining payment information of a payment to be paid in response to a payment operation of a first user;
collecting biometric feature information of the first user;
generating a payment request offline based on the payment information, the biometric feature information, and payment certificate information of an internet-of-things (IoT) device obtained from a first service terminal, the first service terminal being a service terminal corresponding to a payment application of the first user, and the payment certificate information including certificate data and a private key; and
sending the payment request to a second service terminal, for the second service terminal to send the payment request to the first service terminal, and for the first service terminal to perform payment processing based on the payment information and a payment account of the payment application in response to the payment request satisfying a first payment condition, wherein the second service terminal is a service terminal of a merchant corresponding to the IoT device.

17. The computing device according to claim 16, wherein the generating the payment request offline based on the payment information, the biometric feature information, and the payment certificate information of the IoT device includes:
obtaining user identification information of the first user offline based on the biometric feature information;
performing signature processing on the user identification information and time information of a current time based on the private key to obtain signature data; and
generating the payment request based on the signature data, the certificate data, and the payment information.

18. The computing device according to claim 17, wherein the obtaining the user identification information of the first user offline based on the biometric feature information includes:
performing offline matching processing between the biometric feature information of the first user and stored biometric feature information stored in a first storage area; and
in response to the offline matching processing being successful, obtaining user identification information associated with stored biometric feature information that matches with the biometric feature information of the first user, and determining the user identification information as the user identification information of the first user.

19. The computing device according to claim 16, wherein the acts include:
before the determining the payment information of the payment to be paid in response to the payment operation of the first user, and the collecting the biometric feature information of the first user,
sending a device registration request to the first service terminal in response to a registration operation of the merchant, the device registration request including device identification information of the IoT device and merchant identification information of the merchant, for the first service terminal to allocate a public-private key pair to the IoT device including the private key, and to generate the certificate data based on the device identification information, the merchant identification information, and a public key in the public-private key pair; and
receiving the certificate data and the private key sent by the first service terminal.

20. A computing device, comprising a processor and a memory, the memory storing executable instructions, the executable instructions when executed by the processor enable the processor to implement acts including:
receiving, at a first service terminal corresponding to a payment application, a payment request sent by a second service terminal, the payment request including payment information of a payment to be paid;
determining whether the payment request satisfies a payment condition; and
in response to the payment request satisfying the payment condition, performing payment processing based on the payment information,
wherein:
the payment request is sent by an internet-of-things (IoT) device to the second service terminal;
the payment request is generated offline by the IoT device in response to a payment operation of a first user based on the payment information of the payment to be paid, biometric feature information of the first user, and payment certificate information of the IoT device;
the payment certificate information includes certificate data and a private key; and
the second service terminal is a service terminal of a merchant corresponding to the IoT device.
